(19) United States
(12) Patent Application Publication
(10) Pub. No.: US 2026/0163827 A1
(43) Pub. Date: Jun. 11, 2026

(54) METHODS, ARCHITECTURES, APPARATUSES AND SYSTEMS FOR STORING LOGGED SENSING MEASUREMENTS

(71) Applicant: InterDigital Patent Holdings, Inc., Wilmington, DE (US)

(72) Inventors: Jongwoo Hong, New York, NY (US); Fumihiro Hasegawa, Westmount (CA); Ghyslain Pelletier, Montreal (CA); Paul Marinier, Brossard (CA); Moon IL Lee, Melville, NY (US)

(21) Appl. No.: 18/972,317

(22) Filed: Dec. 6, 2024

(51) Int. Cl. H04L 43/04; H04L 43/022; H04W 24/08; H04W 72/1273

(52) U.S. Cl. CPC H04L 43/04; H04L 43/022; H04W 24/08; H04W 72/1273

(57) ABSTRACT

Methods and systems are provided for reporting logged sensing measurements using a wireless transmit/receive unit (WTRU). The WTRU receives, from a network, information indicating a logged sensing configuration for a logged sensing task, wherein the logged sensing configuration comprises a first logging interval, a second logging interval, and at least one trigger condition. The WTRU performs sensing measurements based on the logged sensing configuration to generate a sensing measurement result using the first logging interval and in response to determining that the at least one trigger condition is satisfied, the WTRU performs sensing measurements based on the logged sensing configuration to generate the sensing measurement result using the second logging interval.

### BACKGROUND

The present disclosure is generally directed to the fields of communications, software and encoding, including, for example, to methods, architectures, apparatuses, systems related to storing logged sensing measurements.

### SUMMARY

The present disclosure relates to performing logged sensing measurements and storing results thereof. A wireless transmit/receive unit (WTRU) receives, from a network, a logged sensing measurement configuration comprising conditions according to which the WTRU performs logged sensing measurements and manages (e.g., stores, skips, discards) results thereof.

In certain representative embodiments, methods and systems are provided for reporting a logged sensing measurement. The methods and systems may include a WTRU receiving, from a network, information indicating a logged sensing configuration for a logged sensing task, wherein the logged sensing configuration comprises a first logging interval, a second logging interval, and at least one trigger condition. The methods and systems may also include the WTRU performing sensing measurements based on the logged sensing configuration to generate a sensing measurement result using the first logging interval and in response to determining that the at least one trigger condition is satisfied, performing sensing measurements based on the logged sensing configuration to generate the sensing measurement result using the second logging interval.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a sensing operation of a WTRU according to one or more embodiments;

FIG. 3 illustrates an example of a 5G System assisted automotive maneuvering and navigation according to one or more embodiments;

FIG. 4 illustrates a procedure for minimization of drive-test (MDT) measurement configuration for logged MDT according to one or more embodiments;

FIG. 5 illustrates an example of logged sensing measurement according to one or more embodiments;

FIG. 6 illustrates an example procedure for reporting logged sensing measurements according to one or more embodiments;

FIG. 7 illustrates an example of logged sensing measurement based on one or more conditions according to one or more embodiments;

FIG. 8 illustrates an example for reporting logged sensing measurements and reporting a status based on a condition according to one or more embodiments; and

FIG. 9 illustrates an example method for logged sensing measurement according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

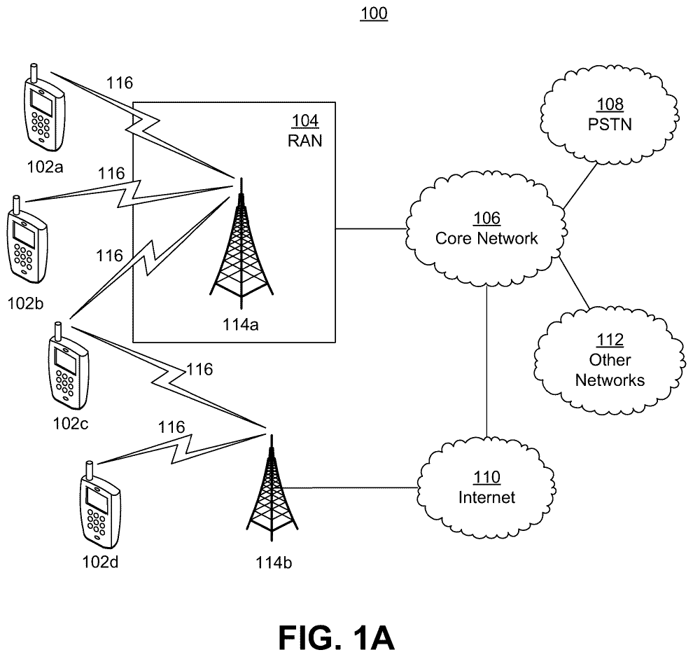

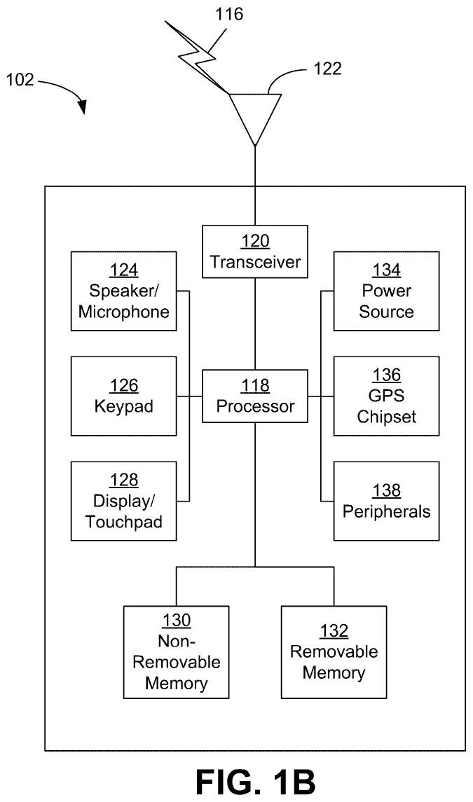

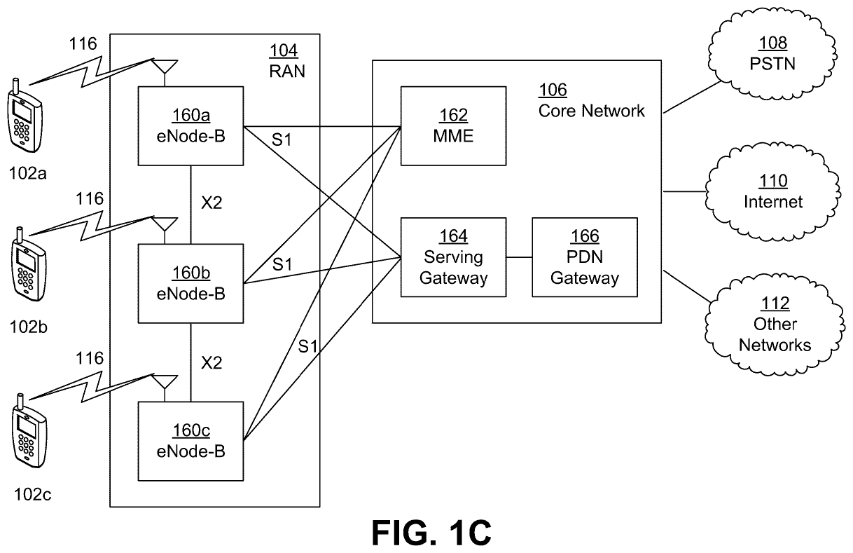

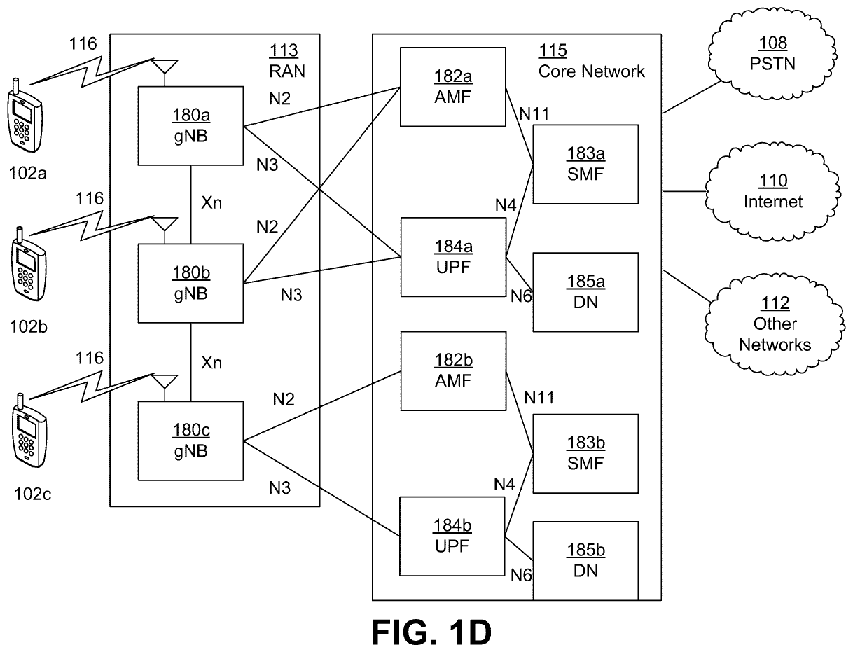

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a New Radio Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANS (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In certain representative embodiments, wireless sensing (e.g., 5G/6G wireless sensing) may be utilized as a technology enabler to acquire information about characteristics of the environment and/or objects within the environment, that uses radio waves to determine the distance (range), angle, or instantaneous linear velocity of objects, etc. The wireless sensing service may rely on analyzing the transmissions, reflections, and scattering of wireless sensing signals.

In certain representative embodiments, integrated sensing and communication technology for enabling new services and use cases for various industries are provided. Wireless sensing service, as part of a cellular network, may provide new possibilities for enhanced usage of the telecommunication infrastructure in areas of object detection and tracking, environment monitoring and human motion monitoring. This may provide input to various verticals-unmanned aerial vehicles (UAVs), smart home, Vehicle-to-Everything (V2X), or factories.

In certain representative embodiments, the use cases may cover a wide range of applications, including: object and intruder detection for smart home, on a highway, for railways, for factory, for predefined secure areas around critical infrastructure; collision avoidance and trajectory tracking of UAVs, vehicles, Automated Guided Vehicles (AGVs); automotive maneuvering and navigation; public safety search and rescue; rainfall monitoring and flooding; health and sports monitoring.

In certain representative embodiments, use cases may be include wireless sensing and some of the use cases may include non-3rd Generation Partnership Project (3GPP) type sensors (e.g., Radar, camera). Wireless sensing service may bring challenges related to confidentiality and privacy. There may be a need to protect the sensing data from unauthorized access, interception and eavesdropping, but also to make sure there is compliance with regulation and user awareness. Based on the use cases, system support (e.g., 5G/6G system support) of different use cases and service requirements for Integrated Sensing and Communication are provided.

In certain representative embodiments, sensing in smart homes is provided. Sensing in a smart home may be an example of a typical scenario of indoor/local-area sensing. Considering people spend most of their lifetime indoors, improving the user experience for an indoor scenario is important. Various WTRUs, e.g. a wearable device, a sensor, a smart phone and/or a customer premise equipment (CPE), may be deployed at home. In order to enjoy more comfortable and convenient indoor life, the various devices may be connected via wireless signals to build a smart home platform.

In certain representative embodiments, in addition to communication purposes, wireless signals may also be used for sensing, e.g., monitoring the home environment continuously.

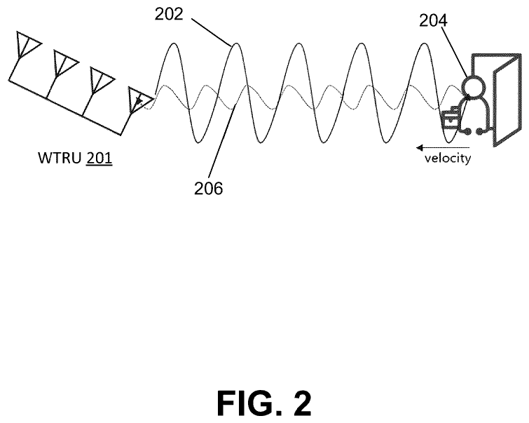

In certain representative embodiments, intruder detection in a smart home scenario is provided. FIG. 2 illustrates an example of a sensing operation of a WTRU 201 according to one or more embodiments. For intruder detection due to the activities of indoor object or human, the signal (e.g., a 3GPP signal) measured by a WTRU or network may be influenced. By analysing and collecting the sensing information such as Doppler frequency shift, amplitude change and phase change, the behaviour of indoor object or human may be detected as shown in FIG. 2. The WTRU 201 may transmit a sensing signal 202 which is reflected by a new reflector 204 (i.e. a moving person with a velocity). A reflected signal 206 may vary in at least one of frequency, phase, amplitude. or time of flight (ToF) from the sensing signal 202.

In certain representative embodiments, to support smart transportation and autonomous driving, more vehicle and devices may be equipped with sensing technologies. In some embodiments, cameras, Radar, and Lidar systems may be the most used sensors by the automotive industry to maintain the perception for autonomous vehicles at various levels of autonomy. Accurate sensing results may be crucial to enable the safe and reliable control of the vehicles.

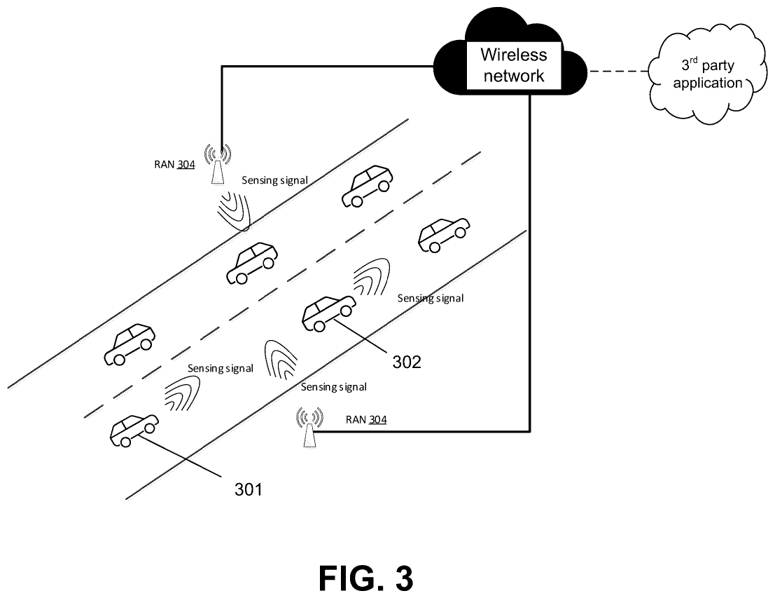

In certain representative embodiments, due to the mounting position of the sensors (e.g., 3GPP based sensors) information collected from a single vehicle's sensors may not be sufficient or accurately enough to satisfy the advanced automotive use cases, e.g., autonomous driving, coordinated maneuver, etc. FIG. 3 illustrates an example of a network (i.e. 5G) system assisted automotive maneuvering and navigation according to one or more embodiments. The system may coordinate a sensing task to get sensing data from various sources and generate sensing results which may be consumed at the vehicle and used for the vehicular control and driver assistance, e.g., feed into the Automated Driving System (ADS) in the vehicle. The network sensing data (i.e. 3GPP network sensing) collected by the WTRU may be sent alongside relevant sensing information to other sensing entities (including other vehicles, roadside units, and network) for further processing (if required) before sharing with a third-party application as shown in FIG. 3.

The network facilitated NR based sensing described above may significantly improve the sensing reliability and quality, enabling new and advanced automotive use cases.

In certain representative embodiments, a first vehicle 301 and a second vehicle 302 may be equipped with wireless-based (i.e. 3GPP-based) sensing technology. Non-wireless (i.e. non-3GPP) sensors such as radar, camera and lidar sensors may also be available in the vehicles. Additionally, the vehicles 301 and 302 may be capable of wireless (i.e. 5G) communications, including direct communication with other vehicles, communication with 5G system via RAN entities 304.

In certain representative embodiments, a wireless (i.e. 5G) system assisted coordination sensing service may comprise one or more of the following steps:

Step 1 (Network may provide configurations and policies): when a first vehicle 301 registers for 3GPP sensing service, the network 304 may provide policies and configurations to enable WTRUs take appropriate actions during sensing e.g., obtaining 3GPP sensing data from other WTRUs/RAN entities. In some embodiments, the policies provided by network may provide guidance for the discovery WTRUs/RAN entities with appropriate radio (i.e. New Radio Reference Frequency NR RF) sensing capabilities, when to trigger requests, when to stop sending requests, messaging formats, the communication configurations (such as which 5G communication mode to use and under which conditions), the sensing configurations (such as which role i.e. transmitter/receiver, to use by a particular node for a particular sensing task, etc. These polices and configurations may be updated frequently by the network based on e.g., network conditions, mobility pattern, etc.

Step 2 (The first vehicle 301 may determine its sensors are blocked): the first vehicle's sensor(s) may be blocked by a second vehicle 302, and may not adequately detect its surroundings (e.g., detect if there is another vehicle in front). This may result in the vehicle miscalculating the needed distance to stop before a traffic light. In other cases, the second vehicle 302 may also reduce the valid sensing region and result in misdetection of incoming vehicles size or shape, especially near intersections. The sensing results may not fully satisfy the autonomous driving needs and requirement.

Step 3 (the first vehicle 301 may recognize need for sensing inputs): Due to unsatisfactory autonomous driving needs and requirements, the WTRU in the first vehicle 301 may be notified that its sensors are blocked and needs wireless (i.e. 5G) system assistance for coordination of the sensing service.

Step 4 (the first vehicle 301 may discover the second vehicle 302): With the policies and configurations provided by the wireless system, the first vehicle 301 may search for neighbouring WTRUs/RAN entities or ask the network to provide recommendations for WTRUs/RAN entities (e.g. considering the current network conditions in the target sensing area) and their wireless (i.e. 3GPP NR RF) sensing capabilities (e.g., if WTRU/RAN entity may support sensing service). This information may be used to discover other vehicles and RAN entities with wireless (i.e. 3GPP NR RF) sensors that can support sensing in the area. In this embodiment, the first vehicle 301 discovered the second vehicle 302 which may be useful in providing sensing inputs.

Step 5 (the first vehicle 301 may connects to the second vehicle 302): the first vehicle 301 may then establish wireless (5G) communication connection with the second vehicle 302 and/or RAN entities. The most suitable 5G communication mode (e.g., broadcast, unicast, etc.) may be determined by the first vehicle 301 based on wireless (i.e. 5G) system configuration and policies.

Step 6 (the first vehicle 301 may request sensing info from the second vehicle 302). The request may indicate the information needed to perform sensing, e.g., the additional region to be covered, additional sensing target, synchronization info, etc.

Step 7 (the second vehicle 302 may send sensing results/wireless (i.e. 3GPP) sensing data to the first vehicle 301) Based on the information provided by the first vehicle; the second vehicle 302 may send the first vehicle 301 wireless (i.e. 3GPP) sensing data identifying objects in its surroundings. It is important to note that when wireless sensing data is shared between the second vehicle 302 and the first vehicle 301, it is expected to be performed in compliance with operator policy on the use of the operator resources (e.g., licensed/unlicensed spectrum).

Step 8a (the first vehicle 301 may process 3GPP sensing data locally) Based on the fact that the first vehicle 301 has non-3GPP sensors (e.g., camera, Lidar), the first vehicle 301 may combine the 3GPP sensing data from the second vehicle 302 with other sensors.

Step 8b (The 5G System expose sensing results to third-party application) Additionally or alternatively the first vehicle 301 may share sensing results and non-3GPP sensing data from the camera and Lidar within the wireless (i.e. 5G) system and then it is exposed by the 5G System to a third-party application server for combination by the third-party. It is important to note that contextual information is information forwarded alongside the sensing results which provide context to the conditions under which the sensing results were derived. This contextual information can be used in scenarios where the sensing result is to be combined with data from other sources. It should also be noted that in case contextual information is required, this information may be shared with the appropriate consent, permissions and subject to operator policy.

In certain representative embodiments, a Downlink-Reference Signal (DL-RS) configuration may contain at least one of the following parameters: number of symbols, transmission power, number of DL-RS resources included in DL-RS resource set, muting pattern for DL-RS (for example, the muting pattern may be expressed via a bitmap), periodicity, type of DL-RS (e.g., periodic, semi-persistent, or aperiodic), slot offset for periodic transmission for DL-RS, vertical shift of DL-RS pattern in the frequency domain, time gap during repetition, repetition factor, RE (resource element) offset, comb pattern, comb size, spatial relation (e.g., with respect to other DL-RSs or Uplink Reference Signal (UL RS) such as Sounding Reference Signal (SRS) for positioning purpose), Quasi co-location (QCL) information (e.g., QCL target, QCL source) for DL-RS, number of Transmission/Reception Points (TRPs), Absolute Radio-Frequency Channel Number (ARFCN), subcarrier spacing, expected Reference Signal time difference (RSTD), uncertainty in expected RSTD, start Physical Resource Block (PRB), bandwidth, Bandwidth Part (BWP) ID, number of frequency layers, start/end time for DL-RS transmission, on/off indicator for DL-RS, TRP ID, DL-RS ID, cell ID, global cell ID, or applicable time window. The WTRU may apply a DL-RS configuration under a condition that the current time is within the applicable time window. “ID” may be used interchangeably with “index”. Examples of DL-RS may be Channel State Information-Reference Signal (CSI-RS), Phase Tracking-Reference Signal (PTRS), Positioning Reference Signal (PRS), Tracking Reference Signal (TRS), and Synchronization Signal Block (SSB).

In certain representative embodiments, UL-RS or SRS configuration may include at least one of: resource ID; comb offset values, cyclic shift values; start position in the frequency domain; number of UL-RS symbols; shift in the frequency domain for UL-RS; frequency hopping pattern; type of UL-RS (e.g., aperiodic, semi-persistent or periodic); sequence ID used to generate UL-RS, or other IDs used to generate UL-RS sequence; spatial relation information, indicating which reference signal (e.g., DL RS, UL RS, CSI-RS, SRS, Demodulation Reference Signal (DM-RS)) or SSB (e.g., SSB ID, cell ID of the SSB) the UL-RS is related to spatially where the UL-RS and DL RS may be aligned spatially; QCL information (e.g., a QCL relationship between UL-RS and other reference signals or SSB); QCL type (e.g., QCL type A, QCL type B, QCL type C, QCL type D); resource set ID; list of UL-RS resources in the resource set; transmission power related information; pathloss reference information which may contain index for SSB, CSI-RS or DL-RS; periodicity of UL-RS transmission; and/or spatial information such as spatial direction information of UL-RS transmission (e.g., beam information, angles of transmission), or spatial direction information of DL RS reception (e.g., beam ID used to receive DL RS, angle of arrival). “ID” may be used interchangeably with “index”. Examples of UL-RS may be SRS and SRS for positioning purpose.

In certain representative embodiments, a sensing configuration may consist of one or more DL-RS or UL-RS configurations. A sensing configuration may consist of measurement or reporting related configurations (e.g., periodicity of measurement or reporting, measurement or reporting trigger conditions, content of the measurement). A sensing configuration may consist of a combination of RS configurations, measurement and/or reporting configurations.

In certain representative embodiments, Reference Signal Time Difference (RSTD) may be defined by the difference in time of arrival between PRSs transmitted from a reference TRP and target TRP. The WTRU may be configured with the reference TRP index and target TRP index. The WTRU may be configured with the PRS resource indices to make measurements. The WTRU may determine the time of arrival from TRP based on one or more PRS resources associated with the TRP. In some embodiments, the RSTD may be defined as the difference in time of arrival between the reference PRS transmitted from a TRP and the target PRS transmitted from a TRP.

In some embodiments, “WTRU Rx-Tx time difference” may refer to the difference between arrival time of the reference signal transmitted by the TRP and transmission time of the reference signal transmitted from the WTRU. The WTRU Rx-Tx time difference may be associated with PRS resource ID and/or SRSp resource ID.

In certain representative embodiments, RS Carrier Phase (RSCP) may be defined as the carrier phase measurement on the PRS. RSCP Difference (RSCPD) may be defined as difference in carrier phase measurements between two PRS resources.

In certain representative embodiments, RSRP per path may be defined as the RSRP per path if the WTRU observers a multipath channel in the measurement. The WTRU may determine RSRP for a DL RS resource. RSRP or RSRPP may be reported using units dBm or relative power difference compared to a reference, e.g., RSRP of the first path, in dB.

In certain representative embodiments, measurement may be a channel impulse response. A channel impulse response, consisting of N paths, may be defined by the following equation

$$h ( t ) = {\sum }_{k = 1}^{N} {h}_{k} ( t ) δ ( t - {τ}_{k} )$$

where hₖ(t) and τₖ are time-varying complex valued coefficient (e.g., expressed by a+bj where j=\sqrt{−1} for the channel impulse response and delay, measured in seconds, for the k^{th}path, respectively. The delta function is defined as δ(t)=1 for t=0 and δ(t)=0 for t≠0.

For a sake of simplicity, the coefficients may be constant over time, e.g., g hₖ(t)=hₖ. The WTRU may report hₖ and τₖ for each path k to the network. The WTRU may report the number of paths, N, to the network. Alternatively, the WTRU may receive hₖ and τₖ for each path k from the network and/or the number of paths.

In certain representative embodiments, the WTRU may obtain Channel Impulse Response (CIR) from the network. The network may indicate PRS configuration(s) such as PRS resource IDs associated with the CIR. For example, the CIR may be associated with PRS resource ID. In this case, the WTRU may determine that the CIR is derived based on the measurements made on the PRS resource associated with the ID. Alternatively, the WTRU may determine that the channel along the direction of transmission of the PRS or reception of the PRS corresponds to the CIR.

In certain representative embodiments, the CIR may be associated with a TRP ID. In this case, the WTRU may determine that the CIR represents the channel between the associated TRP and WTRU. In some embodiments, the CIR may be associated with more than one TRPs where the network may include TRP indices associated with the CIR.

In certain representative embodiments, the CIR may be associated with a cell. In this case, the WTRU may receive cell ID or index associated with the CIR from the network.

In certain representative embodiments, CIR may be associated with more than one TRPs or PRS resource IDs. In this case, the WTRU may determine that the channel between the TRPs and the WTRU may correspond to the CIR. Alternatively, the WTRU may determine that the channel along the transmission directions of PRSs associated with IDs or reception directions of the PRS correspond to the CIR.

In certain representative embodiments, more than one CIRs may be associated with one parameter from PRS configurations (e.g., TRP ID, PRS resource ID, frequency layer ID). For example, the WTRU may receive information related to 2 CIRs associated with a TRP from the network, e.g.,

$${h}_{1} ( t ) = {\sum }_{k = 1}^{{N}_{1}} {h}_{1 , k} ( t ) δ ( t - {τ}_{1 , k} ) and {h}_{2} ( t ) = {\sum }_{k = 1}^{{N}_{2}} {h}_{2 , k} ( t ) δ ( t - {τ}_{2 , k} )$$

from the network. Alternatively, the WTRU may report information related to more than one CIRs associated with PRS configuration (e.g., TRP ID, PRS resource ID) based on the measurements to the network. There can be more than one CIRs associated with PRS configuration since the WTRU or network may observe different channel characteristics based on Angle of Arrival (AoA) of DL RS or UL RS, for example.

Channel impulse response may be represented by delay profile or power delay profile. A power delay profile may be defined as a set of delays and power profiles, such as [τ₀, τ₁, . . . , τ_{N-1}] and [p₀, p₁, . . . , p_{N-1}], where pk may corresponds to relative power at the k^{th} path compared to the first path. A delay profile may be defined as a set of delays [τ₀, τ₁, . . . , τ_{N-1}] which indicates path delay for each path above p_{threshold}. The WTRU may receive p_{threshold} from the network to derive delay profile from power delay profile.

In certain representative embodiments, the WTRU may receive an indication from the network on how to generate CIR, PDP or DP based on timing, phase and/or power measurements. In one example, the WTRU may send a request to the network to receive an indication on which methodologies to use to generate CIR, PDP or DP based on the measurements the WTRU made. For example, the WTRU may receive a message from the network (e.g., via LTE Positioning Protocol (LPP), Radio Resource Control (RRC), Medium Access Control Control Element (MAC-CE), Downlink Control Information (DCI)) indicating the PRS resource indices and associated measurement type(s) (e.g., RSTD, AOA) to use to generate CIR, Power Delay Profile (PDP) or Delay Profile (DP). In one example, the WTRU may receive an indication from the network indicating to generate CIR, PDP or DP.

In certain representative embodiments, the WTRU may receive a threshold (e.g., power threshold) from the network and timing range (e.g., 0 μs to 1 μs), timing granularity (e.g., every 0.1 μs in the indicated timing range, 100 sample points in the indicated timing range) of CIR, PDP and/or DP. In this case, the WTRU may determine to report power and timing (e.g., relative timing compared to a reference timing, absolute timing) any samples whose received power is over the threshold.

The WTRU may send measurements in a report to the network (e.g., LMF, gNB) via a semi-static (e.g., LPP, RRC) or dynamic message (e.g., UCI, UL MAC-CE).

In certain representative embodiments, “PRS”, DL-RS (e.g., CSI-RS, DM-RS, TRS) and SSB may be used interchangeably.

In certain representative embodiments, support of logged minimization of drive-tests (MDT) may comply with the principles for IDLE and INACTIVE state measurements in the WTRU, and principles for IDLE and CONNECTED mode Multimedia Broadcast Multicast System Single Frequency Network (MBSFN) measurements in the WTRU.

In certain representative embodiments, the established principles may result in different logged information in different WTRUs.

Furthermore, measurement logging is differentiated based on WTRU states in idle mode i.e. camped normally, any cell selection or camped on any cell. The WTRU may perform measurement logging in “camped normally” state and “any cell selection” state. In “camped on any cell” state the WTRU may not be required to perform MDT measurement logging (including time and location information).

For logged MDT, the configuration may be done in cells of the same RAT type. However, measurements included in the logged MDT report may comprise of measurements from the same RAT type (serving cell measurements, intra-frequency and inter-frequency neighbor cell measurements) and different RAT types (inter-RAT neighbor cell measurements).

In certain representative embodiments, logging of MBSFN measurements may be applicable to E-UTRA.

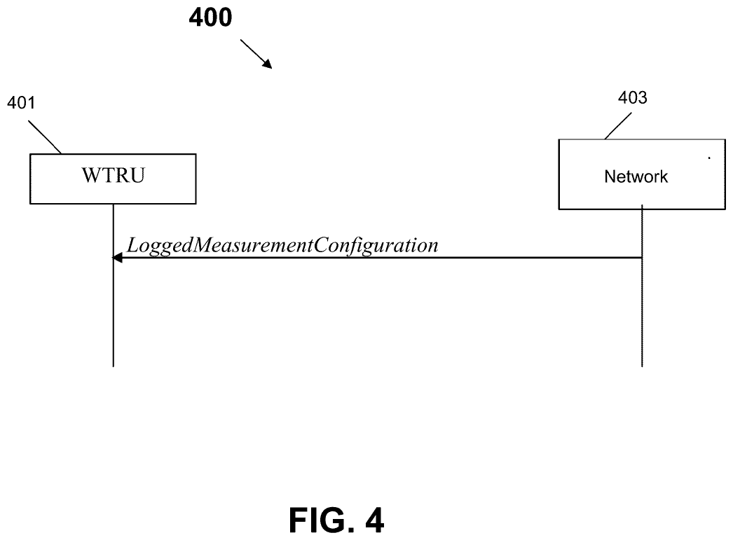

FIG. 4 illustrates a procedure 400 for minimization of drive-tests (MDT) measurement configuration for logged MDT according to some embodiments. Logged MDT measurements may be configured with an MDT Measurement Configuration procedure, as shown in FIG. 4.

A Network 403 may initiate the procedure to a WTRU 401 in RRC Connected by sending LoggedMeasurementConfiguration message, which may be used to transfer configuration parameters for logged MDT. This may be a unidirectional RRC signalling procedure.

A release operation for logged measurement configuration in the WTRU 401 may be realized by configuration replacement when the configuration is overwritten or by configuration clearance in case a duration timer stopping or expiration condition is met.

In certain representative embodiments, a WTRU may be configured to perform logged MDT downlink pilot strength measurements that indicate the availability of logged MDT measurements, by means of a one bit, in RRCConnectionSetupComplete or RRCSetupComplete or RRCConnectionResumeComplete or RRCResumeComplete message during connection establishment. Furthermore, the indicator (possibly updated) may be provided within: Evolved Universal Terrestrial Radio Access Network (E-UTRAN) handover and re-establishment; UTRAN procedures involving the change of Serving RNC (SRNC) (SRNC relocation), CELL UPDATE, URA UPDATE messages as well as MEASUREMENT REPORT message in case of state transition to CELL_FACH without CELL UPDATE; NR re-establishment, reconfiguration.

The WTRU may include the indication in one of these messages at every transition to RRC Connected mode even though the logging period has not ended, upon connection to RAT which configured the WTRU to perform logged MDT measurements and RPLMN which is equal to a PLMN in the MDT PLMN list or currently registered SNPN whose identity is in the stored SNPN identities.

In certain representative embodiments, a WTRU configured to perform logged MDT MBSFN measurements may indicate the availability of logged MDT MBSFN measurements, by means of an indicator, in RRCConnectionSetupComplete message during connection establishment. The indicator (possibly updated) may be provided within E-UTRAN also at handover and re-establishment, except when the logged measurement configuration is active in CONNECTED mode, i.e. except when the logging campaign is still ongoing.

In certain representative embodiments, a WTRU configured to perform logged MDT WLAN measurements may indicate the availability of logged MDT WLAN measurements, by means of an indicator, in RRCConnectionSetupComplete message or RRCConnectionResumeComplete message during connection establishment. Furthermore, the indicator may be included in some uplink RRC messages, i.e., RRCConnectionReconfigurationComplete message, RRCConnectionReestablishmentComplete message, or UEInformationResponse message, at every transition to RRC Connected mode even though the logging period has not ended.

In certain representative embodiments, a WTRU configured to perform logged MDT Bluetooth measurements may indicate the availability of logged MDT Bluetooth measurements, by means of an indicator, in RRCConnectionSetupComplete message or RRCConnectionResumeComplete message during connection establishment. Furthermore, the indicator may be included in some uplink RRC messages, i.e., RRCConnectionReconfigurationComplete message, RRCConnectionReestablishmentComplete message, or UEInformationResponse message, at every transition to RRC Connected mode even though the logging period has not ended.

In certain representative embodiments, a WTRU configured to perform logged MDT WLAN measurements may indicate the availability of logged MDT WLAN measurements, by means of an indicator, in RRCSetupComplete message or RRCResumeComplete message during connection establishment. Furthermore, the indicator may be included in some uplink RRC messages, i.e., RRCReconfigurationComplete message, RRCReestablishmentComplete message, or UEInformationResponse message, at every transition to RRC Connected mode even though the logging period has not ended.

In certain representative embodiments, a WTRU configured to perform logged MDT Bluetooth measurements may indicate the availability of logged MDT Bluetooth measurements, by means of an indicator, in RRCSetupComplete message or RRCResumeComplete message during connection establishment. Furthermore, the indicator may be included in some uplink RRC messages, i.e., RRCReconfigurationComplete message, RRCReestablishmentComplete message, or UEInformationResponse message, at every transition to RRC Connected mode even though the logging period has not ended.

An indicator may be also provided in UEInformationResponse message during MDT report retrieval in case the WTRU has not transferred the total log in one RRC message in order to indicate the remaining data availability.

The WTRU may not indicate the availability of MDT measurements in another RAT or in a PLMN that is not in the MDT PLMN list or in a SNPN whose identity is not in the stored SNPN identities.

The network may decide to retrieve the logged measurements based on this indication. In case logged MDT measurements are retrieved before the completion of the pre-defined logging duration, the reported measurement results may be deleted, but MDT measurement logging may continue according to ongoing logged measurement configuration.

In case the network does not retrieve logged MDT measurements, WTRU may store non-retrieved measurements for 48 hours from the moment the log duration timer for logging expired. There may be no requirement to store non-retrieved data beyond 48 hours. In addition, all logged measurement configuration and the log may be removed by the WTRU at switch off or detach.

In certain representative embodiments, a WTRU in a “camped normally” state may perform logging as per the logged measurement configuration. The “camped normally” state may include a period between cell selection criteria not being met and WTRU entering “any cell selection” state, i.e. 10 s for E-UTRA or 12 s for UTRA or 10 s for NR.

In certain representative embodiments, a WTRU in an “any cell selection” state may perform logging of available information (i.e. at least indicator ‘anyCellSelectionDetected’, time stamp, and the available location information). In certain representative embodiments, a WTRU in a “camped on any cell” state may stop a periodic logging. However, it should be noted that a duration timer (i.e. a log duration timer) may be kept running. When the WTRU re-enters the “camped normally” state and the duration timer has not expired, the WTRU may restart the periodic logging based on new discontinuous reception (DRX) and logging may automatically resumes (with a leap in a time stamp).

In certain representative embodiments, when an E-UTRA or NR WTRU detects an in-device coexistence problem that may affect the logged measurement results, the WTRU may stop measurement logging, indicate in the log that an in-device coexistence problem has occurred, and keep the duration timer running. In certain representative embodiments, when the in-device coexistence problem is no longer present, and the duration timer has not expired, the WTRU may resume logging, with a leap in a time stamp.

In certain representative embodiments, for a E-UTRA Multimedia Broadcast multicast service Single Frequency Network (MBSFN) measurement logging, a WTRU may perform MBSFN measurements only when receiving Multimedia Broadcast Multicast Service (MBMS) service, and perform a E-UTRA Multimedia Broadcast multicast service Single Frequency Network (MBSFN) measurement logging only for logging intervals for which MBSFN measurements are available. The WTRU may perform MBSFN measurements and MBSFN measurement logging in both IDLE and CONNECTED modes. The WTRU may be only required to perform MBSFN measurements when receiving MBMS service of the MBSFN area(s) targeted for logging.

In certain representative embodiments, for WLAN measurement logging and Bluetooth measurement logging, a WTRU may perform WLAN and Bluetooth measurements, respectively, only when indicated in the corresponding configuration. The WTRU may perform the measurement logging only for logging intervals for which WLAN and Bluetooth measurements are available, respectively.

In certain representative embodiments, measurement quantities for downlink pilot strength measurement logging may be fixed and may consist of both Reference Signal Received Power (RSRP) and Reference Signal Received Quality (RSRQ) for E-UTRA, both Reference Signal Cyclic Prefix (RSCP) and Ec/No for Universal Terrestrial Radio Access Frequency Division Duplexing (UTRA FDD), P-CCPCH RSCP for Universal Terrestrial Radio Access (UTRA) 1.28 Mcps Time Division Duplexing (TDD), Rxlev for GSM EDGE Radio Access Network (GERAN), and Pilot Pseudorandom Noise (PN)Phase and Pilot Strength for Code Division Multiple Access 2000 (CDMA2000) if the serving cell is E-UTRAN cell, and both RSRP and RSRQ for NR.

In certain representative embodiments, for NR, in addition to the logged measurement quantities of the camped cell, the WTRU may log a best beam index (SSB Index) along with a best beam RSRP/RSRQ, and a ‘number of good beams’ (the number of SSBs that are above the configured threshold, i.e. absThreshSS-BlocksConsolidation, if configured by the network) associated to cells within a R value range (which is configured by a network for cell reselection) of a highest ranked cell as part of a beam level measurements. Sensor measurements may be logged if available.

In certain representative embodiments, for E-UTRA, a WTRU may log uncompensated barometric pressure measurements if available.

In certain representative embodiments, measurement quantities for E-UTRA MBSFN measurement logging may be fixed and may comprise MBSFN RSRP, MBSFN RSRQ, Block Error Rate BLER for signaling and BLER for data per Multicast Channel (MCH), in addition to measurement quantities for downlink pilot strength measurements.

In certain representative embodiments, measurement quantities for WLAN measurement logging may be fixed and comprise Basic Service Set Identifier (BSSID), Service Set Identifier (SSID), Homogeneous Extended Service Set IDentification HESSID) of Wireless Local Area Network Access Points (WLAN Aps). If configured by the network, measurement quantities for WLAN measurement logging may comprise Received Signal Strength Indicator (RSSI) and Round Trip Time (RTT) if available.

In certain representative embodiments, the measurement quantity for Bluetooth measurement logging may be fixed and comprise a Medium Access Control (MAC) address of Bluetooth beacons. If configured by the network, a measurement quantity for Bluetooth measurement logging may comprise RSSI if available.

In certain representative embodiments, a WTRU may collect MDT measurements and continue logging according to a logged measurement configuration until a memory of the WTRU allocated for storing MDT measurements is full. In this case, the WTRU may stop logging. The WRU may also stop the log duration timer and start a new log duration time set to 48 hours.

In certain representative embodiments, a purpose of this procedure may comprise releasing a logged measurement configuration and a logged measurement information as logged measurement results.

In certain representative embodiments, a WTRU may initiate a procedure upon receiving a logged measurement configuration in the same or another RAT. The WTRU may also initiate the procedure upon power off or upon deregistration of the WTRU. The WTRU may stop the duration timer, e.g., timer T330, if the duration timer is running. Other information associated with log duration timer T330 are disclosed in Table 1. The WTRU may discard, if stored, the logged measurement configuration and the logged measurement information, i.e. the WTRU may release WTRU variables such as VarLogMeasConfig and VarLogMeasReport.

TABLE 1
Timers (Informative)

| Timer | Start | Stop | At expiry |
|---|---|---|---|
| T330 | Upon receiving a | Upon a log volume exceeding a | Perform actions |
| | LoggedMeasurementConfiguration | suitable WTRU memory, or upon | specified in the next |
| | message | initiating a release of a | paragraph |
| | | LoggedMeasurementConfiguration | |
| | | procedure | |

In some representative embodiments, a WTRU may release, upon expiry of a log duration timer such as duration timer T330, VarLogMeasConfig. The WTRU may be allowed, upon expiry of a duration timer such as duration timer T330, to discard stored logged measurements, i.e. the WTRU may release VarLogMeasReport 48 hours after the expiry of the log duration timer.

In certain representative embodiments, a Minimization of Drive Tests (MDT) procedure in RRC (e.g., idle or inactive) may be applied to a logged sensing operation storing results of periodically-performed logged sensing measurements. However, according to the MDT procedure, upon a log volume exceeding a suitable WTRU memory, a WTRU may stop the duration timer (e.g., T330), release the logged sensing measurement operation, discard the results of logged sensing measurements, and then no longer perform the logged sensing measurements.

As a result, a network may not be aware of whether a WTRU is performing a logged sensing operation even when a duration timer is running. In some embodiments, the duration timer may be misaligned between the WTRU and the network Also, the network may not receive any logged sensing measurement results from the WTRU. The WTRU may be unable to report that the WTRU is no longer performing any logged sensing measurements.

In certain representative embodiments, method and systems are provided for how to reduce the logged/stored sensing measurement results and how to report when a WTRU memory is full. Condition(s) may be provided for determining whether to perform logging with different configuration, skip a logged sensing measurement, or delete results of logged sensing measurements, what to report when the WTRU memory is full or an energy level of an energy storage of a WTRU is low, and which subsequent actions the WTRU may perform following the last two events.

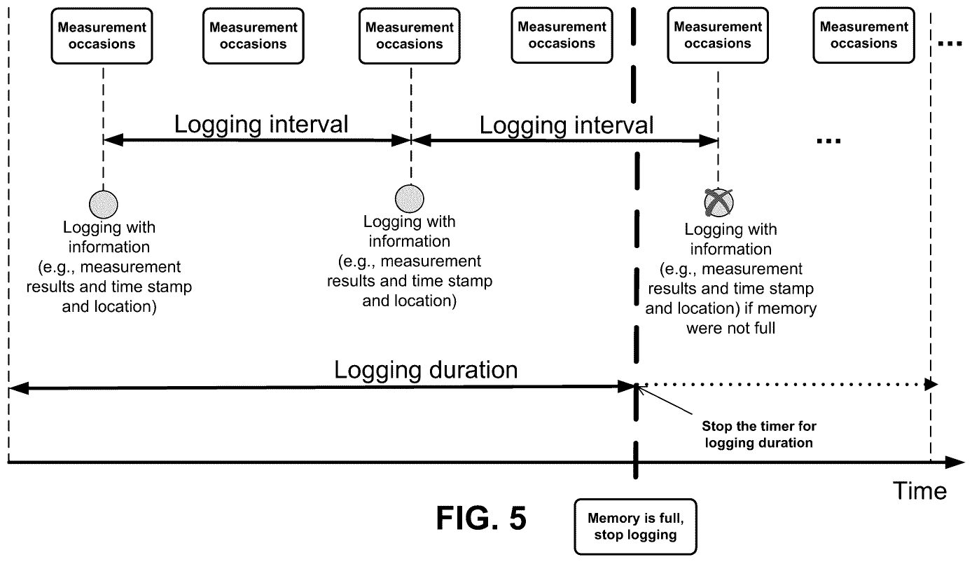

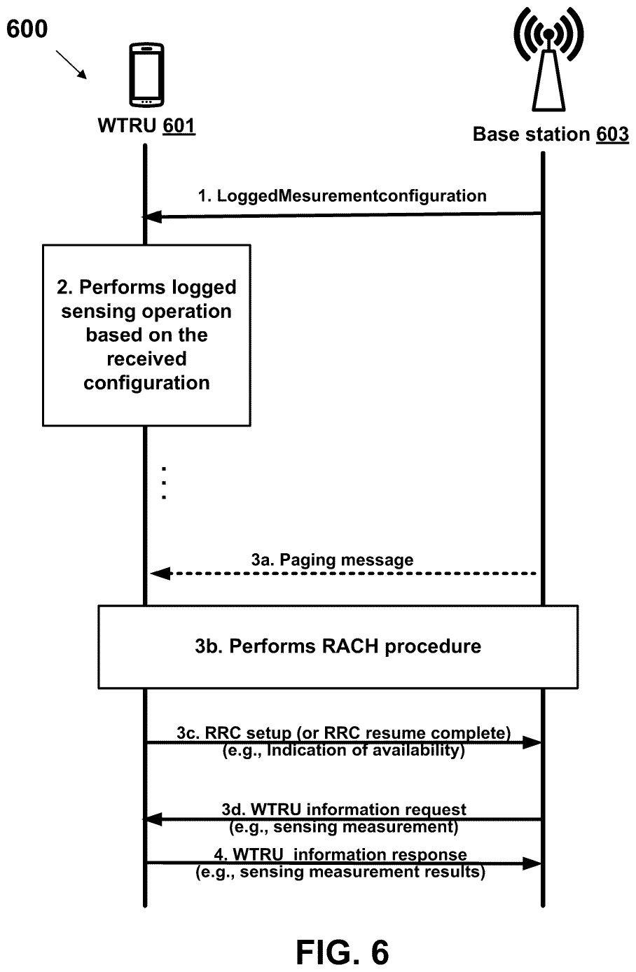

FIG. 5 illustrates an example of logged sensing measurements according to one more embodiments. In this embodiment, a memory of a WTRU allocated for storing results of logged sensing measurements may become full. The WTRU may perform logged sensing measurements based on a periodic logging interval or an event occurring during a logging interval. When the WTRU memory may become full due to logged sensing measurement results, the WTRU may then stop performing logged sensing measurements and store results of earlier logged sensing measurements may be removed later (e.g., at a certain time). FIG. 6 illustrates an example procedure 600 for reporting logged sensing measurements according to one or more embodiments. A base station 603 may transmit a LoggedMesurementconfiguration request to A WTRU 601 at step 1. In response, the WTRU 601 may perform a logged sensing task at step 2. The WTRU 601 may report (for example at step 4) sensing measurement results to the base station 603 after an RRC connection (resumption) is triggered and a RACH procedure is completed (for example, at steps 3a-3d). The WTRU 601 may be similar to any of the WTRUs 102 of FIGS. 1A-1D.

In certain representative embodiments, a WTRU may be configured with one or more conditions for logged sensing measurement and storing the results of the logged sensing measurements. In certain representative embodiments, when a condition (i.e. a trigger condition) is satisfied, the WTRU may determine to perform the logged sensing measurement in the next interval and/or to select a configuration (e.g., periodicity of logging interval).

In certain representative embodiments, a WTRU perform one or actions in the following paragraphs.

The WTRU may receive one or more logged sensing configuration for logged sensing measurement and/or storing results associated with the logged sensing measurements and conditions (i.e. trigger conditions) comprising threshold(s) and/or priorities.

The logged sensing configuration may include associated threshold(s) and/or priorities for one or more logged sensing configuration. Each of the configuration included in the logged sensing configuration may comprise a duration and an interval of logging measurement (e.g., shorter interval or longer interval); threshold(s) of DL-RSRP and associated DL signals; threshold(s) of delta changes (e.g., previous and current logging, or number of logging intervals); threshold(s) of DL-RSRP (e.g., logging measurement, storing results); priorities of each configuration associated DL signals; threshold(s) priorities for performing logging and/or storing results; threshold(s) of current level and/or status (e.g., memory, energy, mobility); location (e.g., cell ID, zone, geographic location).

The logging sensing configuration may further include one or more WTRU actions associated with each condition (i.e., actions that may satisfy one of the conditions). The WTRU actions may include performing logging in next (or after N) logging interval (i.e., skipping the logging measurement in the current interval); extent (or reduce) the period of logging measurement; prioritize logging measurement based on priorities associated with each configuration; storing logging measurement results.

In certain representative embodiments, upon receiving a list of one more one sensing configurations, the WTRU may initiate the logged sensing measurement and/or storing results of the logged sensing measurement based on the received sensing configurations.

In certain representative embodiments, while performing the logged sensing measurement, the WTRU may determine to perform action(s) if at least one of the conditions (i.e., a trigger condition) is satisfied.

In certain representative embodiments, the WTRU may perform logged measurement in next (or after N) logging intervals (i.e., skipping the logging in the current logging interval) if at least one of the following is stratified: the WTRU may be determined to be outside of the configured location; the measured DL-RSRP change is smaller than a threshold of delta change; a measured DL-RSRP value is above a DL-RSRP threshold; a WTRU mobility is higher than a threshold; the remaining memory or energy level is below a threshold(s).

In certain representative embodiments, the WTRU may extent (or reduce) the current interval of the logging measurement. The WTRU may determine to use first (or second) interval of logging measurement from the second (or first) interval of logging measurement (e.g., where first interval is longer than the second interval). This may be in response to at least one of a DL-RSRP change being smaller (or larger) than a threshold of a delta changes; the remaining memory and/or energy level being below a threshold(s).

In certain representative embodiments, the WTRU may prioritize logging measurement among the configured logging measurement based on priorities associated with each configuration and/or sensing measurement result. The priority of a logging measurement configuration may be above a priority threshold for performing logging which may indicate that the logging measurement configuration is high priority.

In certain representative embodiments, the WTRU may skip storing (or removing stored) logging measurement after performing logging if at least one of the following conditions are satisfied. The WTRU may be outside of a configured location; the mobility is higher than a mobility threshold; a remaining memory and/or energy level is below a threshold(s); a measured result of RSRP value is below a DL-RSRP threshold.

In certain representative embodiments, when none of the trigger conditions is satisfied, the WTRU may perform (i.e. continue to perform) the logged sensing measurement based on the received configuration.

In certain representative embodiments, a WTRU may skip or prioritize performing a logged sensing measurement based on one or more WTRU conditions. The WTRU may save memory space and energy while performing the logging and storing logging measurement results.

Throughout this disclosure, the term network may be used interchangeably with AMF, LMF, LMF-like, gNB, eNB, base station or NG-RAN or core network.

Throughout this disclosure, an LMF (or LMF-like function/server) is a non-limiting example of a node or entity (e.g., network node or entity) that may be used for or to support positioning or sensing. Any other node or entity may be substituted for LMF (or like-LMF) and still be consistent with this disclosure.

Throughout this disclosure, the term logged sensing may imply collect sensing measurement results or storing sensing measurement results while performing sensing measurement.

Throughout this disclosure, the term configured threshold, or threshold imply receiving configuration of threshold from network (e.g., base station or core network) or (pre) configured for operating sensing measurement.

Throughout this disclosure, the term sensing operation may imply periodical/event-based logged sensing measurement, storing/logging sensing measurement results, reporting the stored/logged sensing measurement results.

In certain representative embodiments, a WTRU may be configured with one or more sensing configurations (e.g., short and long periodicity of logging measurement) and/or associated WTRU actions with one or more conditions (e.g., skipping logging measurement, extending periodicity of logging interval with selecting different sensing configuration, removing sensing measurement results) from base station and/or core network (e.g., new entity with supporting sensing function or LMF). For example, the sensing configuration may be configured to one or more WTRUs via NAS signaling between WTRU and core network. For example, the sensing configuration may be configured to one or more WTRUs via signaling between WTRU and base station.

In certain representative embodiments, after performing sensing operation, a WTRU may report one or more sensing results to a base station and/or core network entity via request-based and/or signaling-based and/or triggering conditions.

In certain representative embodiments, a base station may transmit a message (e.g., sensing configurations/parameters with including conditions for reporting) to the WTRUs via SIB and/or RRC dedicated message. In some embodiments, each of the sensing configuration may comprise associated DL signals with one or more threshold(s) and/or UL resource (e.g., reporting of sensing results) and/or associated with a periodicity (e.g., when to report sensing results) and/or reporting conditions. In some embodiments, DL signal(s) is associated with at least frequency/a range of resource block(s)/BWP. In some embodiments, the DL signal may include at least one of the DL signals, e.g., SS/PBCH/SSB/SSS. In some embodiments, a WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during sensing operation.

In certain representative embodiments, each of the DL signals is associated with one or more thresholds. In some embodiments, the threshold may be associated with one of measure values e.g., SSB-RSRP and/or SSB-RSRQ and/or SSB-SINR and/or SS-RSRP and/or SS-RSRQ and/or SS-SINR. In some embodiments, each of the threshold of the DL signal may be associated with an obstacle detection (dynamic detection) and/or building detection (semi-static detection). In some embodiments, when the measured value is below than a threshold (during a certain duration time), the WTRU may determine an obstacle is detected and determine to report the measured sensing results to the network.

In certain representative embodiments, each of the DL signals may be associated with at least a measuring time with time window (e.g., number of logging interval, logging duration, duration of slot(s)/subframe(s) and/or periodicity of duration/active time/outside active time). In some embodiments, the measuring time of DL signal(s) may be configured based on the each of the sensing configuration.

In certain representative embodiments, a WTRU may be configured with one or more sensing configuration(s) and related one or more conditions (e.g., threshold, priority, memory, location) indicating how to perform logged sensing measurement and storing sensing measurement results. The WTRU may determine to perform WTRU actions (e.g., skipping the sensing measurement, selecting different periodicity of logging interval) based on the satisfied (pre-) configured conditions.

In certain representative embodiments, a base station may transmit a message (e.g., logged sensing configurations/parameters with including conditions) to the WTRUs via SIB and/or RRC cell-specific/WTRU-dedicated message. In certain representative embodiments, a core network (e.g., LMF or sensing entity) may deliver/configure a message (e.g., logged sensing configurations/parameters) to the WTRUs via NAS signaling to the WTRU. In some embodiments, upon receiving the configuration, a WTRU may perform sensing operation (i.e. sensing task).

In certain representative embodiments, a WTRU may activate sensing measurement and/or storing sensing measurement results with conditions upon receiving activation of sensing configuration. In some embodiments, after receiving the sensing configuration, the WTRU may active the sensing operation with condition(s) upon receiving an indication of sensing activation, e.g., DCI/MAC CE/SIB. In some embodiments, the indication may indicate and active logged sensing configuration with one or more conditions among the configured/received multiple sensing configuration and/or conditions.

In certain representative embodiments, a WTRU may perform logging sensing measurement and/or storing sensing results in next logging interval (i.e., skipping the current logging interval) based on at least one condition (i.e., trigger condition). In some embodiments, the WTRU may determine different configuration (e.g., periodicity of logging interval) of sensing measurement based on at least one of DL-RSRP, memory, energy, location, priority, reconfiguration of periodicity/interval, mobility or an event. DL-RSRP-based: a WTRU may be configured with a threshold of DL-RSRP value (e.g., DL-RSRP delta change and/or DL-RSRP value). In some embodiments, the configured/specified DL signal(s) may be indicated/associated with at least one of DL signals (e.g., SSB index, DL reference, CSI-RS, PTRS, PRS, TRS). In certain representative embodiments, a WTRU may perform logged sensing measurement and/or may store measurement results in next interval (or after N intervals) (i.e., skipping performing logged sensing measurement and/or storing measurement results in the current interval). In some embodiments, the measured change of DL-RSRP value of DL signal may be lower than a threshold of the DL-RSRP delta change (i.e., compared the previous sensing measurement results). In some embodiments, the measured value of DL-RSRP value of DL signal may be higher than a threshold of DL-RSRP value. In some embodiments, the WTRU may be (pre-)configured with the value of skipping N logging intervals.

Memory-based: a WTRU may be configured with a threshold of remaining and/or available memory of WTRU for logged/stored sensing measurement results while performing sensing measurement. The WTRU may be configured with the threshold(s) from receiving configuration from network and/or the WTRU may be (pre-)configured for sensing operation. In some embodiments, (pre-)configured thresholds may comprise one or more levels (e.g., percentage of memory capacity, bytes/bits, available time duration with sensing/storing measurement). Each of the threshold may be (pre-)configured with a device type/device capacity/memory capacity/memory type. In some embodiments, the remaining/available memory of the device may be higher than the (pre-)configured threshold, the WTRU may keep performing logged sensing measurement and/or storing the logged sensing measurement results. In some embodiments, a WTRU may stop performing logged sensing measurement and/or storing logged sensing measurement results when the remaining/available memory of the device is below a (pre-) configured threshold. In some embodiments, the WTRU may stop performing logged sensing measurement and/or storing the logged sensing measurement results immediately and/or after (pre-) configured N logging intervals. In some embodiments, the WTRU may (pre-)configured the N logging intervals before stopping the logged sensing measurement. In some embodiments, the WTRU may determine to report the remaining size of the memory (e.g., in bytes, bits) to the network. The WTRU may receive a request from the network to report the remaining size of the memory. The WTRU may receive an indication or configuration from the network, indicating how such measurements the WTRU may make or how long the WTRU may continue the measurements. In some embodiments, the WTRU may receive an indication to stop performing measurements if the size of accumulated measurements is over a preconfigured threshold (e.g., in bytes). In some embodiments, the WTRU may receive a time window with configured start and end time in absolute time, SFN or relative time with respect to the reference time. The time window may have a duration as a parameter expressed in seconds or frames. The WTRU may receive an indication to make measurements during a configured time window and stop making measurements outside of the time window. In some embodiments, the WTRU may receive, from the network, a duration during which the WTRU is expected to keep the measurements. In some embodiments, the WTRU may receive, from the network, a time duration of N seconds. The WTRU may be expected to keep measurements from the last N seconds where N can be an integer. The WTRU may receive a request from the network to report measurements made in last N seconds. The WTRU may receive a request from the network to process (e.g., find an average) the measurements made in the last N seconds.

Energy-based: a WTRU may be configured with a threshold of remaining and/or available current energy level of WTRU for logged/stored sensing measurement results while performing sensing measurement. The WTRU may be configured with the threshold(s) from receiving configuration from network and/or the WTRU may be (pre-)configured for sensing operation. In some embodiments, the configured threshold(s) may comprise one or more levels (e.g., percentage of energy, available/remaining time (e.g., msec/sec/mins) duration with sensing and/or storing measurement results). Each of the threshold(s) may be configured with a device type/device capacity. In some embodiments, a WTRU may stop performing logged sensing measurement and/or storing the measurement results when the current energy level of the device is below a threshold. In some embodiments, the WTRU may stop performing logged sensing measurement and/or storing the logged sensing measurement results immediately and/or after (pre-)configured N logging intervals. In some embodiments, the WTRU may be (pre-)configured the N logging intervals before stopping the logged sensing measurement. In some embodiments, the WTRU may determine to report the remaining energy (e.g., msec/sec/hours) to the network. The WTRU may receive a request from the network to report the remaining energy of WTRU. The WTRU may receive an indication or configuration from the network, indicating how such measurements the WTRU should make or how long the WTRU should make measurements. In some embodiments, the WTRU may receive an indication to stop making measurements if the current energy of WTRU is below the (pre-)configured threshold (e.g., time window). In another example, the WTRU may receive a time window with configured start and end time in absolute time, SFN or relative time with respect to the reference time. The time window may have a duration as a parameter expressed in seconds or frames. The WTRU may receive an indication to make measurements during a configured time window and stop making measurements outside of the time window. In some embodiments, the WTRU may receive, from the network, a duration during which the WTRU is expected to keep the measurements. In some embodiments, the WTRU may receive, from the network, a time duration of N seconds. The WTRU may be expected to keep measurements from the last N seconds where N can be an integer. The WTRU may receive a request from the network to report measurements made in last N seconds. The WTRU may receive a request from the network to process (e.g., find an average) the measurements made in the last N seconds.

Location-based: a WTRU may be (pre-)configured with one or more geographical locations. The location may be associated with specific DL signal(s)/cell(s)/cell IDs/PLMN ID/zone/tracking area/geographical coordination/absolute (relative) positioning information. In some embodiments, a WTRU may determine the current location based on RAT dependent (e.g., DL-TDOA) and/or RAT independent positioning techniques. The WTRU may trigger reporting logged sensing measurement results with positioning techniques (or based on the estimated positions). The WTRU may receive positioning related configurations (e.g., DL-RS, positioning method to use) from the network (e.g., LMF or sensing entity). In some embodiments, when a WTRU is located (at least) within the configured location(s), the WTRU may keep performing logged sensing measurement and/or storing measurement results. In some embodiments, when a WTRU is located (or moved) out of the (pre-)configured locations, the WTRU may stop performing logged sensing measurement and/or storing the sensing measurement results with handover and/or cell reselection procedure. In some embodiments, the WTRU may a WTRU is moved within the (pre-)configured locations, the WTRU may resume the (stopped) logged sensing measurement and/or storing the sensing measurement results.

Priority-based: a WTRU may be (pre-)configured with priorities of DL signals (e.g., SSB, PSS, DL-RS). Each of the DL signals may be configured with related sensing measurement (and storing sensing measurement results). Each of the DL signal may be configured with at least one priority level (e.g., the priority level may be expressed in terms of numbers or explicit levels such as “high”, “medium”, “low”). In some embodiments, a WTRU may be configured with a threshold of priority of logging measurement. In some embodiments, when a WTRU is configured a threshold of priority of logging measurement, the WTRU may select and perform the logging measurement with one or more DL signals comprising/configured higher priority than the configured threshold of priority of logging measurement. In some embodiments, when the WTRU may select and not perform the logging measurement with one or more DL signals comprising/configured lower priority than the configured threshold of priority of logging measurement. In some embodiments, the WTRU may be configured with 10 SSBs to measure and log corresponding measurements where each SSB is associated with a priority level. The WTRU may receive a threshold for the priority level (e.g., 5). The WTRU may determine to prioritize to measure SSBs whose priority is higher than the configured priority level. In some embodiments, the WTRU may determine to prioritize measurements based on a condition (e.g., remaining WTRU storage space is below a threshold, remaining battery power is below a threshold). The WTRU may determine to prioritize measurements based on the configured priority level. In some embodiments, a WTRU may be configured with a threshold of priority of storing sensing measurement results. In some embodiments, when a WTRU may be configured a threshold of priority of storing sensing measurement, the WTRU may select and store the logging measurement with one or more DL signals comprising/configured higher priority than the configured threshold of priority of logging measurement. In some embodiments, when the WTRU may select and not store the logging measurement with one or more DL signals comprising/configured lower priority than the configured threshold of priority of logging measurement. In some embodiments, a WTRU may be configured with a threshold of priority of removal the stored sensing measurement (e.g., logged/stored measurement results in the past intervals). In some embodiments, when a WTRU may be configured a threshold of priority of removal the storing sensing measurement, the WTRU may remove the logging measurement with one or more DL signals comprising/configured lower priority among the stored sensing measurement results. Also, the WTRU may filter out (e.g., results with lower priorities) and report logged sensing measurement results with one or more DL signals configured with higher priorities than the configured thresholds of priorities.

Reconfiguration of periodicity/interval: a WTRU may extend the current periodicity/interval (e.g., msec/sec/min) of logged sensing measurement and/or subsequent storing sensing measurement results. In some embodiments, the WTRU may select first interval (e.g., longer interval from the current interval or second interval) of logging measurement among the configured with multiple intervals of logging measurement (e.g., shorter interval and/or longer interval). In some embodiments, the change of DL-RSRP value (compared the measurement in the past) of DL signal is below a threshold of the DL-RSRP delta change. In some embodiments, the current energy level of the device may be below a configured threshold. In some embodiments, the remaining/available memory of the device may be below a configured threshold. In some embodiments, a WTRU may shorten the current periodicity/interval (e.g., msec/see/min) of logged sensing measurement and/or subsequent storing sensing measurement results. The WTRU may select second interval (e.g., shorter interval from the current interval or first interval) of logging measurement among the configured intervals of logging measurement when a condition is satisfied. In some embodiments, the change of DL-RSRP value (compared the previous measurement) of DL signal is above a threshold of the DL-RSRP delta change. In some embodiments, the current energy level of the device may be above a configured threshold. In some embodiments, the remaining/available memory of the device may be above a configured threshold. In some embodiments, the WTRU may determine to change preconfigured measurement occasions if at least one condition is satisfied. In some embodiments, the WTRU may be configured to log measurements every 5 ms. If at least one of the conditions (e.g., low battery, low remaining storage space) is satisfied, the WTRU may determine to increase/extend logging measurement periodicity to one of the preconfigured periodicities (e.g., 10 ms). In some embodiments, the WTRU may determine select a configured type(s) of measurements based on a condition. The WTRU may determine to select a subset of configured types of measurements based on the condition associated with the subset. In some embodiments, the WTRU may be configured to select both power and timing (e.g., RSTD, multipath measurements, PDP, DP, CIR) measurements by the network (e.g., LMF, gNB). The WTRU may determine to select power measurement only if the associated condition is satisfied (e.g., low remaining battery power, remaining storage space is below the configured threshold). In some embodiments, the WTRU may determine to select power, timing and phase measurement if a condition is satisfied (e.g., the remaining battery power and storage space are above configured thresholds).

Mobility based: a WTRU may be (pre-)configured with a threshold of WTRU mobility for logged/stored sensing measurement results while performing sensing measurement. The WTRU may be configured with the threshold(s) from receiving configuration from network and/or the WTRU may be (pre-)configured for sensing operation. In some embodiments, a WTRU may stop performing logged sensing measurement and/or storing the logged sensing measurement results when the WTRU mobility is above a (pre-)configured threshold. In some embodiments, the WTRU may stop performing logged sensing measurement and/or storing the logged sensing measurement results immediately and/or after (pre-)configured N logging intervals. In some embodiments, the WTRU may resume the (stopped) logging measurement when the WTRU mobility is below a (pre-)configured threshold.

Event-based: the WTRU may determine to log measurements based on an event. The event may be mobility of the WTRU, detection of mobility of the obstacle or target, detection of the presence of a target, detection of multipath measurement, detection of a change in measurement (e.g., RSRP below a threshold), etc. The WTRU may receive configurations for event(s) (e.g., thresholds). In some embodiments, the WTRU may determine to log measurement based on an event if the WTRU condition satisfies a criterion (e.g., battery power below the configured threshold, the remaining memory storage is below the configured threshold). In some embodiments, the WTRU may receive configurations to log measurements periodically. If one of the WTRU conditions satisfies the configured criterion (e.g., reaming memory storage size is low), the WTRU may determine to log measurements based on the configured events.

In certain representative embodiments, any combinations of the above factors may be provided. In some embodiments, one condition may be satisfied. In some embodiments, several conditions may be satisfied. In some embodiments, a threshold for one condition may be computed based on another factor, etc.

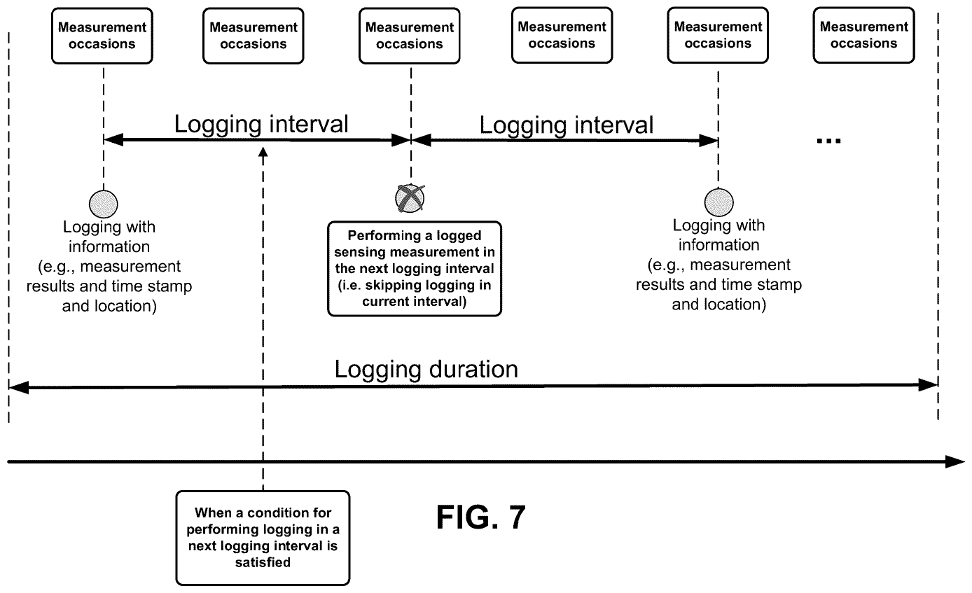

FIG. 7 illustrates an example of logged sensing measurement and WTRU actions based on one or more conditions according to one or more embodiments. In some embodiments, a WTRU may receive logged sensing configuration and associated WTRU actions with conditions (i.e. trigger condition) from base station or core network. Upon receiving the logged sensing configuration, the WTRU may initiate sensing operation based on the received sensing configuration. The WTRU may measure indicated DL signal(s) and/or perform logging sensing measurement and/or store measurement results.

In certain representative embodiments, while performing logged sensing operation, a WTRU may determine to perform the logged sensing measurement in the next (or after N) interval (i.e., skipping logged sensing measurement and/or storing measurement results in the current interval) when a condition for skipping the logging is satisfied. In some embodiments, the condition may be that a current remaining memory and/or energy of the WTRU may be below a (pre-)configured threshold.

In certain representative embodiments, a WTRU may be configured with logged sensing measurement configuration and reporting conditions. When a condition (e.g., memory, energy) is satisfied, the WTRU may report an indication (i.e., unavailability of logged sensing) to a network.

In certain representative embodiments, a WTRU may perform at least one of the steps described in the following paragraphs.

A WTRU may receive at least one logged sensing configuration measurement and reporting conditions comprising at least one threshold. The logged sensing configuration may comprise associated threshold(s) and/or priorities, including at least one of: each of the configurations may comprise a duration and an interval of logging measurement (e.g., shorter interval or longer interval); threshold(s) of triggering status reporting (e.g., memory, energy). The logging configuration may comprise WTRU actions associated with conditions including at least one of: stop logged sensing measurement and/or storing sensing measurement results; trigger reporting to the network.

Upon receiving a list of sensing configurations, the WTRU may initiate the logged sensing measurement and/or storing results based on the received sensing configurations.

While performing the logged sensing measurement, the WTRU may determine to report when at least one of the triggering conditions is satisfied. The WTRU may transmit an indication of unavailability (e.g., logged sensing) to the network based on at least one of the remaining memory of WTRU being below a memory threshold for reporting to the network, or The remaining energy of WTRU being below an energy threshold.

In certain representative embodiments, when none of the trigger conditions is satisfied, the WTRU may perform (i.e. continue to perform) the logged sensing measurement based on the received configuration.

In certain representative embodiments, a WTRU may report the status (e.g., availability or unavailability) of logged sensing measurement to a network. The WTRU may trigger the reporting to the network when the WTRU is no longer performing logging due to a triggering condition (e.g., memory being fully occupied or low energy) and therefore the network may be aware of the WTRU not logging and that subsequent sensing measurement results are no longer available.

In certain representative embodiments, a WTRU may be configured with one or more trigger conditions for reporting a WTRU status by a base station and/or a core network (e.g., new entity or server with supporting sensing function or LMF). In certain representative embodiments, a WTRU may report the WTRU status (e.g., unavailability of logged sensing measurement and/or sensing measurement results) within in the UL indication (e.g., UCI and/or new MAC CE and/or SR and/or BSR) and/or UL RRC messages (e.g., MSG 3/5, WTRU information response, WTRU assistance information). In certain representative embodiments, the WTRU may be configured (via RRC release message and/or SIB message), by the network (e.g., LMF, gNB) with reporting occasions (e.g., msg3, configured grants, dynamic grants) to report unavailability of logged sensing. In certain representative embodiments, the WTRU may send an indication to the network to indicate unavailability of logged sensing, In some embodiments, via msg1 or sending a configured preamble. In some embodiments, the WTRU may receive a configuration (e.g., via RRC release message and/or broadcasting SIB) for preamble sequence(s) and time and/or frequency resources to send the configured preamble sequences for indication of unavailability of logged sensing. In another example, the WTRU may send a request to the network to send the indication (e.g., unavailability of logged sensing) when a triggering reporting is satisfied. Once the WTRU may receive a grant and resources from the network to send the indication, the WTRU may determine to send the indication to the network.

In certain representative embodiments, a WTRU may perform logged sensing measurement and/or storing sensing results in next logging interval (i.e., skipping the current logging interval) based on one or more conditions. In certain representative embodiments, the WTRU may determine different configuration (e.g., periodicity of logging interval) of sensing measurement based on at ones one of memory or Energy.

Memory-based: a WTRU may be configured with a threshold for remaining and/or available memory of WTRU for status reporting while performing sensing measurement. The WTRU may be configured with condition associated threshold from receiving configuration from network and/or the WTRU may be (pre-)configured for sensing operation. In some embodiments, a WTRU may determine to report status of logged sensing measurement when the condition (i.e., remaining memory level being below than (pre-)configured threshold) is satisfied. In some embodiments, the WTRU may stop performing logged sensing measurement immediately and/or stop performing the logged sensing measurement after (pre-)configured N logging intervals. In some embodiments, a WTRU may report a status with an indication to a network. In some embodiments, the indication may include unavailability of logged sensing measurement with stopping logged sensing measurement. In some embodiments, the WTRU may send the indication with a cause value (e.g., low memory) to a network. In some embodiments, the WTRU may include an additional indication with availability of stored sensing measurement results, if the WTRU stored valid sensing measurement results.

Energy-based: a WTRU may be configured with a threshold for remaining and/or available current energy level of WTRU for logged/stored sensing measurement results while performing sensing measurement. The WTRU may be configured with a condition associated with a threshold when receiving the configuration from the network and/or the WTRU is (pre-) configured for sensing operation. In certain representative embodiments, the WTRU may determine to report status of logged sensing measurement when condition (i.e., energy level being below than (pre-)configured threshold) is satisfied. In some embodiments, the WTRU may stop performing logged sensing measurement immediately and/or after (pre-)configured N logging intervals. In certain representative embodiments, the WTRU may report a status with an indication to the network. In some embodiments, the indication may include unavailability of stored sensing measurement. In some embodiments, the WTRU may send the indication with a cause value (e.g., low energy), to a network. In some embodiments, the WTRU may include an additional indication with availability of stored sensing measurement results, if the WTRU stored valid sensing measurement results.

In certain representative embodiments, when the WTRU determines to send the indication (e.g., unavailability of logged sensing), the WTRU may determine to stop logging measurements. The WTRU may receive an indication from the network to delete the logged measurements from the WTRU's storage space. The WTRU may receive an indication to start logging measurements after deleting the logged measurement from the WTRU's storage space.

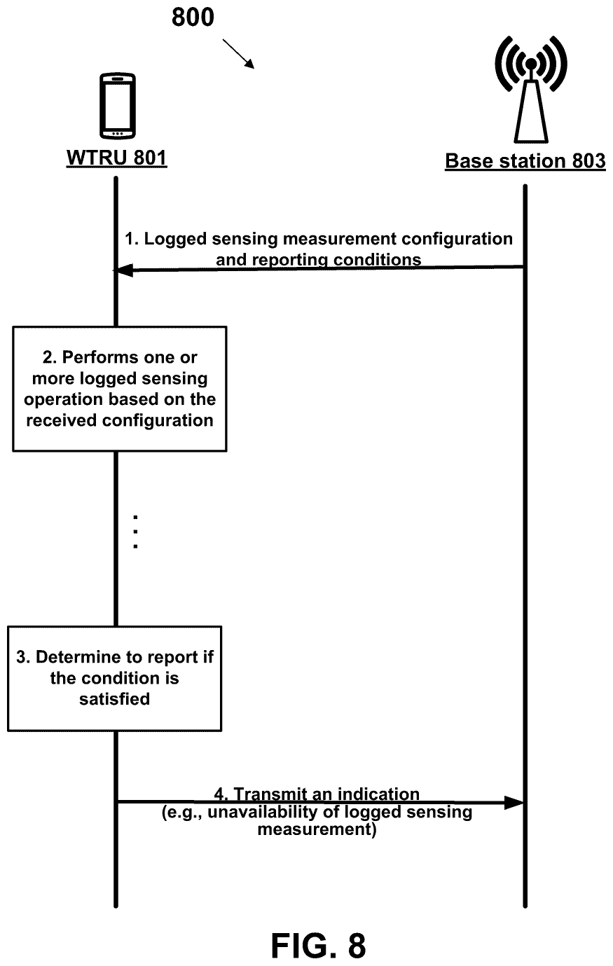

FIG. 8 illustrates an example of logged sensing measurement and reporting a status based on a condition according to one or more embodiments. A WTRU 801 may receive logged sensing configuration and associated triggering conditions (e.g., memory and/or energy) for reporting from a base station 806 at step 1. Upon receiving the logged sensing configuration, the WTRU 801 may initiate sensing operation based on the received sensing configuration at step 2. While performing logged sensing operation, the WTRU 801 may determine to report the status of logged measurement (i.e., unavailability of logged sensing measurement) to the base station 803 when a (pre-)configured condition is satisfied (e.g., current energy or remaining memory being below than the (pre-)configured threshold) at step 3. The WTRU 801 may transmit an indication, for example of unavailability of logged sensing measurement to the base station 803 at step 4. The WTRU 801 may be similar to any of the WTRUs 102 of FIGS. 1A-1D.

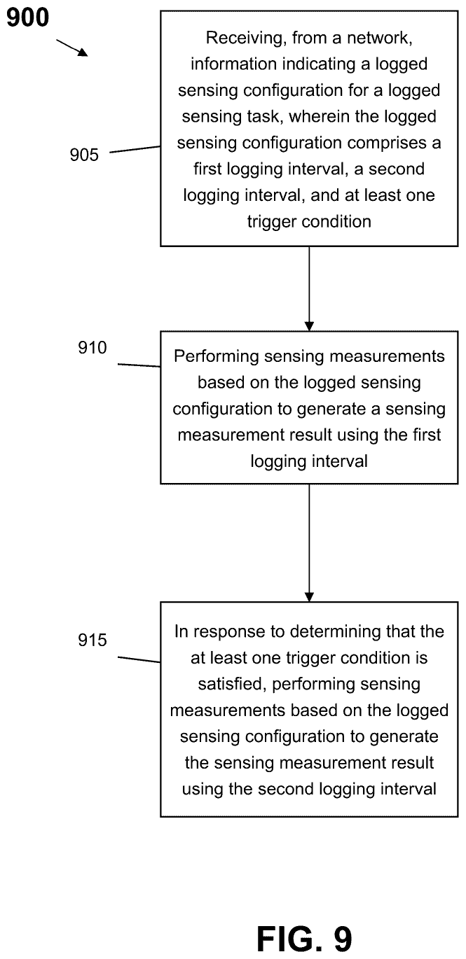

FIG. 9 illustrates an example method 900 for a logged sensing measurement according to one or more embodiments. The method 900 may be performed by a WTRU such as any of the WTRUs 102 of FIGS. 1A-1D, the WTRU 201 of FIG. 2, the WTRU 401 of FIG. 4, the WTRU 601 of FIG. 6, or the WTRU 801 of FIG. 8. The method 900 may include receiving 905, from a network, information indicating a logged sensing configuration for a logged sensing task, wherein the logged sensing configuration comprises a first logging interval, a second logging interval, and at least one trigger condition. In some embodiments, the receiving 905 may correspond to step 1 of FIG. 6 or 8. The method 900 may further include performing 910, sensing measurements based on the logged sensing configuration to generate a sensing measurement result using the first logging interval. In some embodiments, the performing 910 corresponds to step 2 of FIG. 6 or 8. The method 900 may further include in response to determining that the at least one trigger condition is satisfied, performing 915, sensing measurements based on the logged sensing configuration to generate the sensing measurement result using the second logging interval.

In some embodiments, the second logging interval may be longer than the first logging interval.

In some embodiments, the at least one trigger condition may comprise at least one of a threshold associated with a memory of the WTRU, a threshold associated with an energy level of the WTRU, a threshold associated with a change in consecutive downlink signals for the logged sensing task, or a threshold associated with WTRU mobility.

In some embodiments, the sensing measurement result may be a first sensing measurement result, and the method 900 may further comprises performing sensing measurements based on the logged sensing configuration to generate a second measurement result using the first logging interval; and wherein the logged sensing configuration comprises a first priority value associated with the first sensing measurement result and a second priority value associated with the second sensing measurement result.

In some embodiments, in response to determining that the at least one trigger condition is satisfied, the method 900 may further comprise continuing to perform sensing measurements based on the logged sensing configuration to generate the second sensing measurement result using the first logging interval.

In some embodiments, the second priority value associated with the second sensing measurement result is greater or smaller (e.g., lower priority or higher priority) than the first priority value associated with the first sensing measurement result.

In some embodiments, in response to determining that the at least one trigger condition is satisfied, the method 900 may further comprise terminating the performing sensing measurements based on the logged sensing configuration to generate the second sensing measurement result using the first logging interval.

In some embodiments, the method 900 further may comprise reporting, to the network, an indication of a status of the sensing task.

In some embodiments, the performing sensing measurements based on the logged sensing configuration to generate the sensing measurement result based on the first logging interval may comprise performing sensing measurements using the first logging interval or logging the sensing measurement result using the first logging interval, or both.

In some embodiments, the at least one trigger condition may comprise information associated with a location; and the determining that the at least one trigger condition is satisfied based on at least the sensing measurement result may comprise determining that the WTRU is outside the location.

In some embodiments, the at least one trigger condition may be a first trigger condition, and the logged sensing configuration may further comprise a second trigger condition. The method 900 may further comprise in response to determining that the second trigger condition is satisfied, terminating the sensing task, and reporting, to the network, an indication of unavailability of the WTRU for the sensing task.

In some embodiments, in response to determining that the at least one trigger condition is satisfied and after one or more logging intervals, the method 900 may comprise performing sensing measurements based on the logged sensing configuration for the logged sensing task to generate the sensing measurement result.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ or means-plus-function claim format, and any claim without the terms “means for” is not so intended.

What is claimed is:

1. A method performed by a wireless transmit/receive unit (WTRU), comprising:
receiving, from a network, information indicating a logged sensing configuration for a logged sensing task, wherein the logged sensing configuration comprises a first logging interval, a second logging interval, and at least one trigger condition;
performing sensing measurements based on the logged sensing configuration to generate a sensing measurement result using the first logging interval; and
in response to determining that the at least one trigger condition is satisfied, performing sensing measurements based on the logged sensing configuration to generate the sensing measurement result using the second logging interval.

2. The method of claim 1, wherein the second logging interval is longer than the first logging interval.

3. The method of claim 1, wherein the at least one trigger condition comprises at least one of a threshold associated with a memory of the WTRU, a threshold associated with an energy level of the WTRU, a threshold associated with a downlink signal for the logged sensing task, a threshold associated with a change in consecutive downlink signals for the logged sensing task, or a threshold associated with WTRU mobility.

4. The method of claim 1, wherein the sensing measurement result is a first sensing measurement result, and the method further comprises:
performing sensing measurements based on the logged sensing configuration to generate a second sensing measurement result using the first logging interval; and
wherein the logged sensing configuration comprises a first priority value associated with the first sensing measurement result and a second priority value associated with the second sensing measurement result.

5. The method of claim 4, further comprising:
in response to determining that the at least one trigger condition is satisfied, continuing to perform sensing measurements based on the logged sensing configuration to generate the second sensing measurement result using the first logging interval.

6. The method of claim 5, wherein the second priority value associated with the second sensing measurement result indicates a higher priority than the first priority value associated with the first sensing measurement result.

7. The method of claim 4, further comprising:
in response to determining that the at least one trigger condition is satisfied, terminating the performing sensing measurements based on the logged sensing configuration to generate the second sensing measurement result using the first logging interval.

8. The method of claim 1, further comprising:
reporting, to the network, an indication of a status of the sensing task.

9. The method of claim 1, wherein the performing sensing measurements based on the logged sensing configuration to generate the sensing measurement result using the first logging interval comprises:
performing sensing measurements using the first logging interval or logging the sensing measurement result using the first logging interval, or both.

10. The method of claim 1, wherein the at least one trigger condition comprises information associated with a location; and
the determining that the at least one trigger condition is satisfied based on at least the sensing measurement result comprises determining that the WTRU is outside the location.

11. The method of claim 1, wherein the at least one trigger condition is a first trigger condition, and the logged sensing configuration further comprises a second trigger condition, the method further comprising:
in response to determining that the second trigger condition is satisfied, terminating the sensing task, and
reporting, to the network, an indication of unavailability of the WTRU for the sensing task.

12. The method of claim 1, further comprising:
in response to determining that the at least one trigger condition is satisfied and after one or more logging intervals, performing sensing measurements based on the logged sensing configuration for the logged sensing task to generate the sensing measurement result.

13. A wireless transmit/receive unit (WTRU) comprising:
a processer; and
a transceiver, wherein the WTRU is configured to:
receive, from a network, information indicating a logged sensing configuration for a logged sensing task, wherein the logged sensing configuration comprises a first logging interval, a second logging interval, and at least one trigger condition;
perform sensing measurements based on the logged sensing configuration to generate a sensing measurement result using the first logging interval; and
in response to determining that the at least one trigger condition is satisfied, perform sensing measurements based on the logged sensing configuration to generate the sensing measurement result using the second logging interval.

14. The WTRU of claim 13, wherein the second logging interval is longer than the first logging interval.

15. The WTRU of claim 13, wherein the at least one trigger condition comprises at least one of a threshold associated with a memory of the WTRU, a threshold associated with an energy level of the WTRU, a threshold associated with a downlink signal for the logged sensing task, a threshold associated with a change in consecutive downlink signals for the logged sensing task, or a threshold associated with WTRU mobility.

16. The WTRU of claim 13, wherein the sensing measurement result is a first sensing measurement result, and the WTRU is further configured to:
perform sensing measurements based on the logged sensing configuration to generate a second sensing measurement result using the first logging interval; and
wherein the logged sensing configuration comprises a first priority value associated with the first sensing measurement result and a second priority value associated with the second sensing measurement result.

17. The WTRU of claim 16, wherein the WTRU is further configured to:
in response to determining that the at least one trigger condition is satisfied, continue to perform sensing measurements based on the logged sensing configuration to generate the second sensing measurement result using the first logging interval.

18. The WTRU of claim 16, wherein the WTRU is further configured to:
in response to determining that the at least one trigger condition is satisfied, terminate the performing sensing measurements based on the logged sensing configuration to generate the second sensing measurement result using the first logging interval.

19. The WTRU of claim 13, wherein the WTRU is further configured to:
report, to the network, an indication of a status of the sensing task.

20. The WTRU of claim 13, wherein, when performing the sensing measurements based on the logged sensing configuration to generate the sensing measurement result using the first logging interval, the WTRU is further configured to:
perform the sensing measurements using the first logging interval or logging the sensing measurement result using the first logging interval, or both.
